(19) United States
(12) Patent Application Publication
(10) Pub. No.: US 2023/0274562 A1
(43) Pub. Date: Aug. 31, 2023

(54) BOOTSTRAPPED SEMANTIC PREPROCESSING FOR MEDICAL DATASETS

(71) Applicant: UNIVERSITY OF SOUTH FLORIDA, Tampa, FL (US)

(72) Inventors: Christopher Collazo, Tampa, FL (US); Lawrence Hall, Tampa, FL (US); Dmitry Goldgof, Tampa, FL (US); Samuel Wickline, Tampa, FL (US); Hua Pan, Tampa, FL (US)

(21) Appl. No.: 18/175,305

(22) Filed: Feb. 27, 2023

Related U.S. Application Data
(60) Provisional application No. 63/314,278, filed on Feb. 25, 2022.

(51) Int. Cl. G06V 20/69; G06V 20/70; G06V 10/774; G06V 10/82; G06V 10/778

(52) U.S. Cl. CPC G06V 20/695; G06V 20/698; G06V 20/70; G06V 10/774; G06V 10/82; G06V 10/7788; G06V 2201/03

(57) ABSTRACT

Bootstrapped semantic preprocessing techniques for medical datasets such as whole slide histopathology image datasets can be used to more efficiently and effectively train artificial intelligence used for medical purposes. The bootstrapped semantic preprocessing techniques generally include deriving metrics from image features and adjusting images according to the metrics. This process can be repeated iteratively for unknown and unlabeled data using a bootstrapping technique to normalize unknown samples to the training dataset distribution.

### CROSS-REFERENCE TO RELATED APPLICATIONS

This application claims the benefit of and priority to U.S. Provisional Patent Application No. 63/314,278, filed Feb. 25, 2022, the entirety of which is hereby incorporated by reference herein.

### STATEMENT REGARDING FEDERALLY SPONSORED RESEARCH

This invention was made in part with government support identified under Grant Number R21HL154009 awarded by the National Institutes of Health (NIH) to HP.

### BACKGROUND

In machine learning applications, the ability to generate ground truth data can involve significant financial costs and other inefficiencies (e.g., requiring excessive resources for manual data labeling). These problems can be compounded when large quantities of data and/or large data files, such as images or videos, are used for processing. Accordingly, systems and methods that can reduce the excessive cost and thereby improve efficiency of various ground truth and training data generation processes are generally desired.

In particular, systems and methods that can reduce cost and improve efficiency for generation of training data in healthcare applications is especially needed. There are a limited number of trained experts (e.g. radiologists, pathologists, etc.), who have a limited amount of time to review medical test results (e.g., patient images, such as images of sample slides, etc.). And, the amount of time it takes a human expert to review each result can be lengthy. Thus, having a more effective way to minimize the time it takes a human expert to review results can greatly improve healthcare for many individuals.

### SUMMARY

Preprocessing techniques for medical datasets as disclosed herein can include receiving an image of a specimen; processing the image to separate pixels in the image into a first class and a second class; determining a first average brightness value for the first class of pixels and a second average brightness value for the second class of pixels; adjusting the first average brightness value for the first class of pixels in the image by a step increment to produce a first adjusted image; applying the first adjusted image to a machine learning model to generate a first label for the first adjusted image; adjusting the first adjusted image to produce a second adjusted image; applying the second adjusted image to the machine learning model to generate a second label for the second adjusted image; adding the second label and the second adjusted image to a training dataset used to train the machine learning model; and training the machine learning model using the training dataset.

Adjusting the first average brightness value for the first class of pixels in the image by the step increment to produce the first adjusted image can include adjusting the first average brightness value such that the first average brightness value moves closer towards a third average brightness value associated with a target image. The techniques can further include determining a fourth average brightness value for the first adjusted image, where adjusting the first adjusted image to produce the second adjusted image includes adjusting the fourth average brightness value such that the fourth average brightness value moves closer towards the third average brightness value associated with the target image. The techniques can further include adjusting at least one of a first average contrast value or a first average gamma value for the first class of pixels in the image by the step increment to produce the first adjusted image. The image can be a full resolution, full slide digital image capturing fine details about the specimen.

The techniques can further include determining a first standard deviation of brightness values for the first class of pixels in the image, a second standard deviation of contrast values for the first class of pixels in the image, and a third standard deviation of gamma values for the first class of pixels in the image, and adjusting the first average brightness value, the first average contrast value, and the first average gamma value can include adjusting the first average brightness value, the first average contrast value, and the first average gamma value such that the first standard deviation moves closer towards a fourth standard deviation of brightness values associated with the target image, the second standard deviation moves closer towards a fifth standard deviation of contrast values associated with the target image, and the third standard deviation moves closer towards a sixth standard deviation of gamma values associated with the target image.

Processing the image to separate the pixels in the image into the first class and the second class can include processing the image using an Otsu threshold to separate the pixels in the image into the first class and the second class. The techniques can further include causing the second label and the second adjusted image to be presented to a user via a user interface and receiving an input from the user via the user interface, where the input is used to add the second label and the second adjusted image to the training dataset. The techniques can further include determining a confidence value for the second label by evaluating the second label using a snapshot ensemble. The machine learning model can be a U-Net convolutional neural network.

### BRIEF DESCRIPTION OF THE DRAWINGS

For a more complete understanding of the disclosure, reference is made throughout the description to the accompanying figures, briefly described as follows:

FIG. 1 is a block diagram showing an example system for bootstrapped semantic preprocessing for medical datasets, in accordance with some aspects.

FIG. 2 is an illustration of a sample section from a dataset used in testing the system of FIG. 1, in accordance with some aspects.

FIG. 3 illustrates histograms showing the distributions for different dataset cohorts used in testing the system of FIG. 1, in accordance with some aspects.

FIG. 4 is a diagram showing an architecture of a convolutional neural network model used in testing the system of FIG. 1, in accordance with some aspects.

FIG. 5 illustrates of foreground and background region of interest segmentation for a sample section used in testing the system of FIG. 1, in accordance with some aspects.

FIG. 6 illustrates correlation plots for nuclear stain and lectin-488 channel average class area pixel values used in testing the system of FIG. 1, in accordance with some aspects.

FIG. 7 is a flowchart showing an example process for implementing bootstrapped semantic preprocessing for medical datasets that can be performed using the system of FIG. 1, in accordance with some aspects.

FIG. 8 is a flowchart showing another example process for implementing bootstrapped semantic preprocessing for medical datasets that can be performed using the system of FIG. 1, in accordance with some aspects.

FIG. 9 is a flowchart showing an example process for active deep learning that can be enhanced using the system of FIG. 1, in accordance with some aspects.

FIG. 10 illustrates point clusters demonstrating how gradient descent bootstrapped semantic preprocessing normalized an unknown dataset to a training dataset during testing of the system of FIG. 1, in accordance with some aspects.

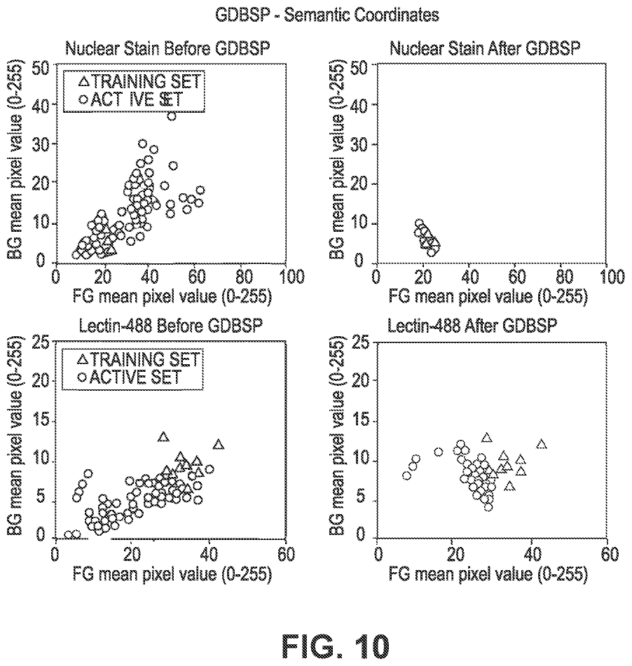

FIG. 11 illustrates Dice accuracies of iterative preprocessing using bootstrapped semantic preprocessing at different iterations found during testing of the system of FIG. 1, in accordance with some aspects.

FIG. 12 illustrates gamma adjustment semantic preprocessing iterations found during testing of the system of FIG. 1, in accordance with some aspects.

FIG. 13 illustrates average brightness values for foreground and background regions for different channels found during testing of the system of FIG. 1, in accordance with some aspects.

FIG. 14 illustrates an example of an overfitting ensemble misclassifying labels relevant to the system of FIG. 1, in accordance with some aspects.

FIG. 15 is a table illustrating dataset sample counts used during testing of the system of FIG. 1, in accordance with some aspects.

FIG. 16 is a table illustrating results of a Cohort 1 experiment associated with the system of FIG. 1, in accordance with some aspects.

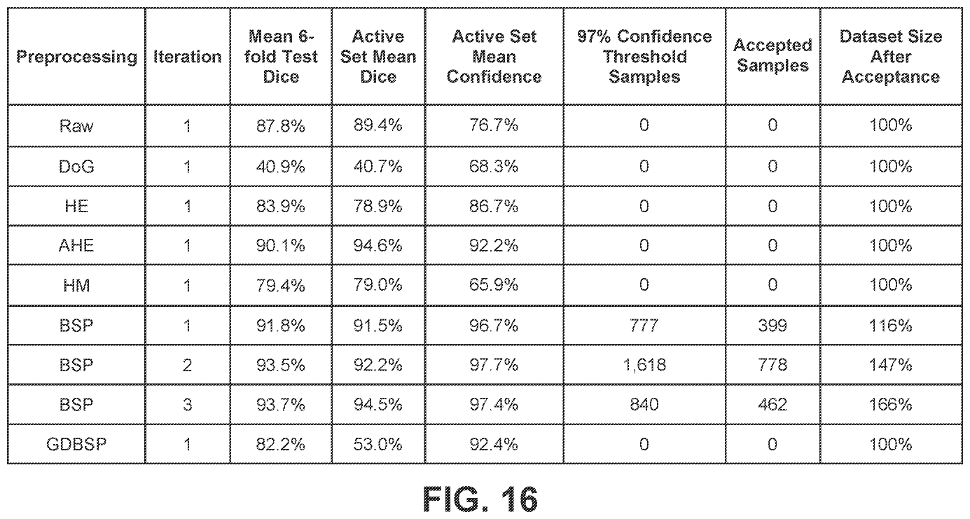

FIG. 17 is a table illustrating results of experiments for Cohorts 2 and 3 relative to the Cohort 1 experiment associated with the system of FIG. 1, in accordance with some aspects.

FIG. 18 is a table illustrating sample acceptance results of the experiments for Cohort 2 and 3 associated with the system of FIG. 1, in accordance with some aspects.

FIG. 19 is a table illustrating results of a gradient descent bootstrapped semantic preprocessing experiment associated with the system of FIG. 1, in accordance with some aspects.

FIG. 20 is a flowchart showing another example process for implementing bootstrapped semantic preprocessing for medical datasets that can be performed using the system of FIG. 1, in accordance with some aspects.

### DETAILED DESCRIPTION

Since the United States Food and Drug Administration (FDA) approved the first whole slide image system for medical diagnosis in 2017, whole slide images have provided enriched critical information to advance the field of medical histopathology. The field of medical histopathology generally involves microscopic examination of tissue in order to study the manifestations of disease. However, progress in this field has been greatly hindered due to the tremendous cost and time associated with generating region of interest (ROI) ground truth for supervised machine learning, alongside concerns with inconsistent microscopy imagining acquisition. Ground truth represents information generally known to be real or true, provided by direct observation and measurement as opposed to information that is instead generated by inference. Active learning has presented a potential solution to these problems by expanding dataset ground truth by algorithmically choosing the most informative data samples for ground truth labeling. In active machine learning approaches, learning algorithms can interactively query a user (e.g., a subject matter expert) to manually label new data with the desired outputs. However, these approaches still incur the costs of human labeling efforts which need minimization.

Alternatively, automatic labeling approaches using active learning tend to overfit and select data samples that are most similar to the training dataset distribution while excluding out-of-distribution samples that might be informative and improve model effectiveness. The inconsistent cross-microscopic images can induce the bulk of this disparity. The inconsistencies present in datasets can be quantified and demonstrated for various applications. A deep learning-based preprocessing method that aims to normalize unknown samples to the training data set distribution and short-circuit the overfitting problem can be used. The preprocessing method can greatly increase the amount of automatic region of interest ground truth labeling possible on high resolution whole slide images with active deep learning. In an example application discussed in more detail below, 92% of automatic labels generated for an unlabeled data cohort were accepted, thereby expanding the existing labeled dataset by 845%. Also, a 96% expert time savings relative to manual expert ground truth labeling was demonstrated.

In general, deep learning and convolutional neural networks can be highly effective and useful tools in medical imaging, histopathology, and diagnosis. Even so, labeling histopathology image datasets to generate ground truth for training deep learning algorithms is one of the ongoing challenges to adoption of artificial intelligence in medical practice. In an ideal world, all possible histopathology images would be curated, labeled, collected, and available at any time for anyone to train universally robust machine learning algorithms. However, this often is not possible due to limitations on resources and time. The expense of many expert person-hours of work hand-labeling data for deep learning training sets is often so high that it hinders development of related technology.

Approaches such as crowdsourcing and substantially downsizing images used in datasets have drawbacks. Moreover, laws and standards differ between localities, regions, and nations, with many places stringently gating the public release of medical information due to privacy concerns. As a result, datasets often must be constructed in isolation or as a cooperative effort between institutions to reach the required sample count. Unfortunately, this limits production throughput and the number of samples that can be produced, as well as introducing a host of new concerns for image data collection. When images are acquired, the microscopy, curation, and labeling often are done at different times by different people using different equipment and different specimens. Accordingly, image features are often inconsistent across datasets, and automated methods often produce questionable results due to the sensitivity to these variabilities.

The inventors initially recognized that active learning may be a promising potential solution to generate ground truth data with reduced human efforts. While most variants of active learning work by selecting the most useful samples for the expert to label the region of interest via a carefully considered uncertainty metric, this approach still requires manual ground truth generation by hand and therefore is not ideal due to the required time and cost. An approach referred to as “active deep learning” (ADL) uses a snapshot ensemble that votes to automatically label samples and automatically submits the highest confidence (highest vote proportion) samples for approval by the expert. Using this approach, the input required by the expert can be limited to simple “accept” or “reject” decisions. However, due to the aforementioned imagine inconsistency issues, active deep learning manifests a pattern of diminishing returns, accepting only a subset of the active unknown dataset for inclusion into the training dataset (in some examples, only 55% of samples accepted after 5 iterations).

The confidence metric of active deep learning can select the subset of samples that most closely resemble the training dataset distribution while rejection out-of-distribution samples as noted above, which is a classic overfitting scenario. In order to mitigate this overfitting problem, a preprocessing method can be used to normalize new samples to the distribution of the training dataset. As a result, confidence scores for active deep learning and sample acceptance rates can be improved, and further reduction of human effort required to integrated artificial intelligence and human intelligence can be achieved.

The preprocessing method can be referred to as a Bootstrapped Semantic Preprocessing (BSP) method, as discussed in further detail below, can be used on input images to remedy the overfitting issue. In this context, Semantic Preprocessing (SP) refers to a preprocessing method wherein adjustments can be made more consistently than with methods based on local or histogram metrics. This can be done by obtaining a semantic metric relevant to the dataset distribution from areas of interest in the deep learning model's prediction. For example, a semantic metric that can be used is the mean pixel value for each region of an image. The regions and metrics for an image, which are unknown before prediction and obtained by analyzing the prediction, can be used to retroactively make preprocessing adjustments via a bootstrapping process. The performance of the preprocessing method can be boosted by augmenting it with a gradient descent process using multiple types of image processing techniques in series, an approach that can be referred to as Gradient Descent Bootstrapped Semantic Preprocessing (GDBSP).

The semantic preprocessing methodology consider class-based image features, derives a simple metric from these features (e.g., the mean brightness of each class area), and adjusts the image according to this feature-aware or semantic metric. By repeating this process iteratively for unknown and unlabeled data using the bootstrapping technique, an active deep learning snapshot ensemble can normalize unknown samples to the training dataset distribution. As a result, one can increase prediction quality, negate overfitting issues, and improve the likelihood that evaluated samples will be accepted by a human expert. As detailed below, these improvements were demonstrated on full resolution whole slide images, with no downsizing or loss of detailed via the use of patch-wise interpolation. The preprocessing approach can be adopted beyond histological images for use in other medical imaging contexts, as well as other image processing contexts.

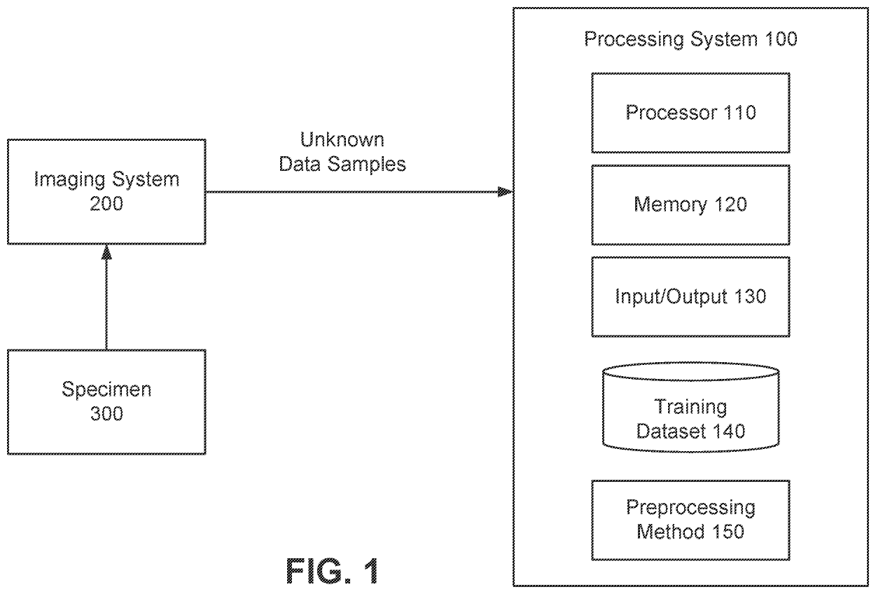

FIG. 1 shows a block diagram of an example system for bootstrapped semantic preprocessing for medical datasets. The system includes a data processing system 100, an imaging system 200, and a specimen 300. The imaging system 200 can be any kind of system used for generating digital images of biological materials, including systems capable of generating whole slide histopathology images of biological tissues. For example, the imaging system 200 can be a Philips IntelliSite Pathology Solution system, or another similar type of system. The specimen 300 can be any type of biological sample used for medical analysis. For example, the specimen 300 can be a biopsy or a surgical specimen placed onto a glass slide for microscopic examination to study the manifestations of disease.

The processing system 100 is shown to include a processor 110, a memory 120, inputs and outputs 130, a training dataset 140, and a preprocessing method 150. The processing system 100 can be implemented in a variety of ways, including through use of a data center, one or more on-premises servers, one or more personal computing devices, a mainframe, etc., and various combinations thereof, as will be appreciated by the skilled person. The processor 110 can be implemented using a variety of different types and combinations of components, including processing devices such as microprocessors, central processing units (CPU), graphics processing units (GPU), single core processors, multi-core processors, etc. The inputs and outputs 130 can generally include any outgoing data or incoming data transmitted or received through a variety of suitable hardware and/or software interfaces, including over various wired and wireless networks including local networks and/or the Internet. The processing system 100 can also cause a user interface to be presented to a user, such as a subject matter expert, in conjunction with active deep learning processes as discussed herein.

The memory 120 can likewise be implemented in a variety of manners, including using various types of volatile memory and/or non-volatile memory. The memory 120 can include non-transitory computer-readable storage having instructions stored thereon that that, when executed by the processor 110, causes the processor to implement different operations, including execution of the preprocessing method 150. The preprocessing method 150 can be stored as instructions within the memory 120 that can be executed by the processor 110. The preprocessing method 150 can be implemented in various ways, such as using approaches including bootstrapped semantic preprocessing and gradient descent bootstrapped semantic preprocessing as detailed herein. The training dataset 140 can include training data used to train one or more machine learning models, such as the model 400 described below, such that the model can provide more accurate automated functionality. The preprocessing method 150 can output labeled data and add that labeled data to the training dataset 140 to expand the training dataset 140 for better training.

One embodiment of a preprocessing method 150 was first demonstrated by the inventors, using fluorescence microscopy images of mouse hearts to analyze the extent of ischemic tissue damage following myocardial infarction (AMI), a “heart attack”. The experimentation and associated results discussed below are intended to illustrate the functionality and advantages of the preprocessing method 150, but are not limiting on the scope of potential use of the preprocessing method 150. The inventors have determined that the general approach underlying the following example may be utilized for similar applications, which are contemplated herein.

Twenty C57BL6 mice underwent left anterior descending (LAD) coronary artery ligation for 90 minutes, followed by reperfusion for 24 hours, before sacrifice. After the hearts were excised and perfused with saline, the LAD coronary artery was reoccluded and 50 microliters (μL) of Lycopersicon Esculentum (Tomato) Lectin (LEL, TL, DyLight® 488 (Cat #: DL-1174-1, Vector Laboratories, Burlingame, Calif.) (hereinafter referred to as “lectin-488”) in 1 milliliter (mL) saline was perfused to label blood vessels located in the nonischemic region. The hearts were then cut into five sections, embedded in optimal cutting temperature compound (O.C.T.) (Cat #: 23-730-571, FisherSci, Pittsburgh, Pa.), and sectioned at 8 micrometers (μm) for fluorescence imagining. Before imaging, heart sections were fixed and washed, before mounted with VECTASHIELD® Antifade Mounting Medium with DAPI (Cat #: H-1200-10, Vector Laboratories, Burlingame, Calif.) for imaging by using an Olympus fluorescence microscope. Images were taken with the fluorescence microscope at a selection of specific wavelengths for the specific fluorophores. In this manner, a total of 100 sections were obtained with two images per section. The first image was a nuclear stain image which defined the region of tissue section. The second image was a lectin-488 image which defined the region of tissue with normal blood flow throughout the experimental procedures.

The 100 sample selections collected were split between three cohorts. Cohort 1 included 11 sections from 11 mice, with expert ground truth. Cohort 2 included 45 sections from 9 additional mice. Cohort 3 included 44 sections from the same 9 mice as Cohort 2. Cohort 1, having ground truth, was split into the initial training, validation, and cross-validation test sections. Cohorts 2 and 3, having no ground truth, composed the active, unknown dataset from which sections will be integrated into the training dataset 140 as active learning generates approved ground truth region of interest labels.

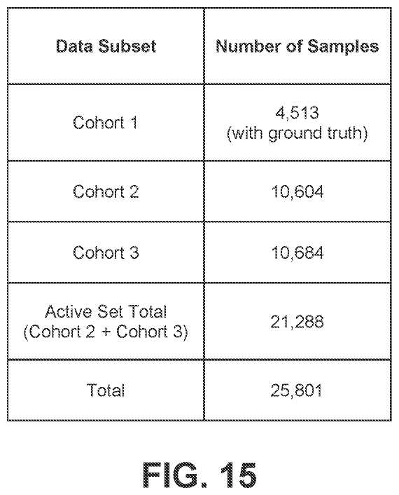

Each section image, taken at 162.5 nanometers per pixel (nm/pixel) resolution, was downscaled by a factor of 0.3, resulting in a resolution of 541.67 nm/pixel and roughly 10,000 pixels per side. However, these images are high resolution and too large to be evaluated in whole by a neural network of a reasonable size for computation. For prediction, these section images were cut into a grid of 512×512 pixel patches that acted as input samples to the neural network (model 400 detailed below). The associated sample counts are shown in the table of FIG. 15. Due to the large number of section in the unlabeled cohorts, the opportunity to expand the available ground truth by a potential multiple of 5 existed in a perfect scenario. Even without the perfect result, a much larger amount of data could be labeled than Cohort 1. Moreover, the cohorts displayed significant inter-cohort and intra-cohort variability.

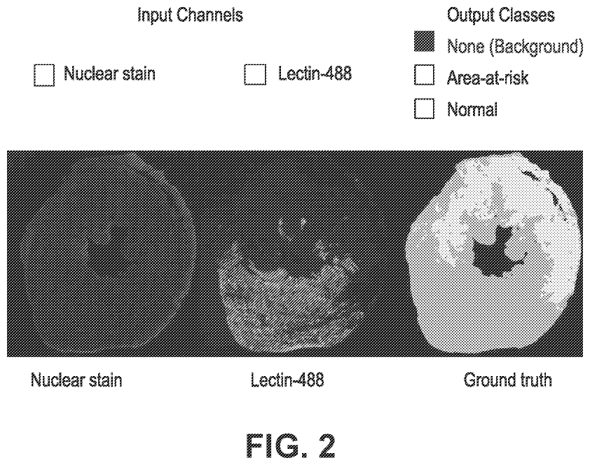

The inputs to the neural network included the 100 sections consisting of 25,801 sample patches in total. Each section was composed of two images: nuclear stain which defined the presence of cells in the heart section, and lectin-488 which showed blood vessels in the nonischemic cardiac tissue. Accordingly, there were two input channels for the neural network. FIG. 2 illustrates a sample section from the dataset, with a legend for interpreting false coloration. On the left is the nuclear stain channel identifying total tissue area. In the center is the lectin-488 channel identifying blood reperfusion. On the right is the ground truth map, indicating normal and at-risk areas as well as background areas. The goal of the neural network was to segment the samples according to whether any given region of pixels corresponds to the background of the slide outside of the tissue section, the ischemic area-at-risk (AAR) of cell death, and the area of nonischemic normal blood flow perfusion. Thus, the neural network output three channels: none (background), risk, and normal. These output channels were used for visualizing ground truth or output region of interest segmentation maps.

All input images were converted to 8-bit pixel depth, yielding grayscale intensity values from 0 to 255, with 0 being black and 255 being white. The value from 0 to 255 was generally referred to as the “brightness”, the “intensity”, and the “pixel value” during the experimentation. Considering the path-grid split discussed above, the individual neural network inputs and outputs can now be considered. For inputs, two combined image channels were used to form a 512×512×2 patch. For output, a 512×512×3 confidence map patch was produced, where each pixel's value indicates the model's proportional confidence in each class at that pixel. During prediction, the output patched of the neural network were stitched together to form a whole section, as discussed in more detail below.

Expert ground truth was generated for Cohort 1's 11 sections. A full region of interest segmentation map containing none, risk, and normal regions was “hand-painted” in the GNU Image Manipulation Program (GIMP) such that, for each tissue class, any given pixel in the entire section image must belong to one of the classes. The lectin-488 signal closely matched normal vascular structures; however, normal healthy tissue fell as many as 26 nm outside of the lectin-488 vascular signal area, using the assumption that the nucleus is in the center of the cells and cell walls fall on average 26 nm away from the nucleus. This margin was considered when constructing the ground truth class map. FIG. 2 illustrates an example of one of these 11 section's input channels and ground truth segmentation map.

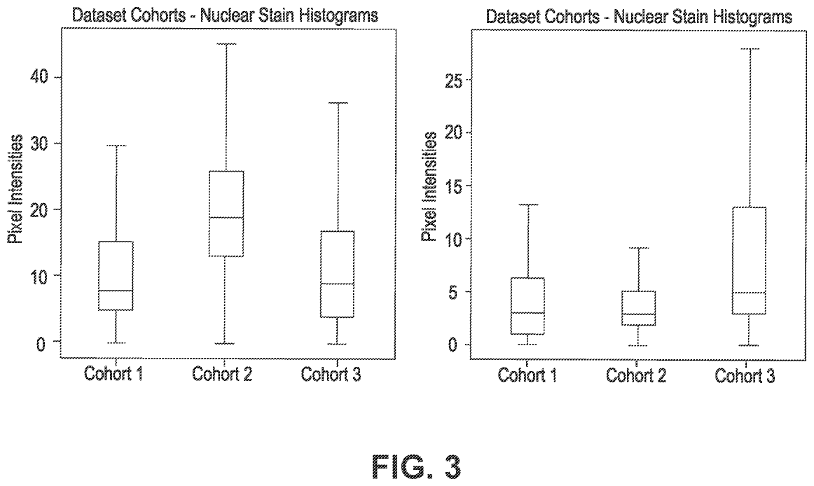

The distributions of each cohort's channels vary quite significantly. FIG. 3 illustrates histograms showing the distributions for dataset cohorts. Cohort 1, again, was the training and cross-validation data, while Cohort 2 and Cohort 3 were the active unknown dataset. The deviation of the Cohort 2 nuclear stain channel and the Cohort 3 lectin-488 channel was notable. Cohort 2's nuclear stain was exceptionally bright, with most of it corresponding to Cohort 1's upper quartile. Cohort 3′s lectin-488 channel skewed bright, with its upper quartile exceeding Cohort 1's maximum. Even when collecting with a specification for the process, deviations from the training set distribution should be expected and prepared for. The goal of the semantic preprocessing is to normalize the cohorts robustly for more effective deep learning.

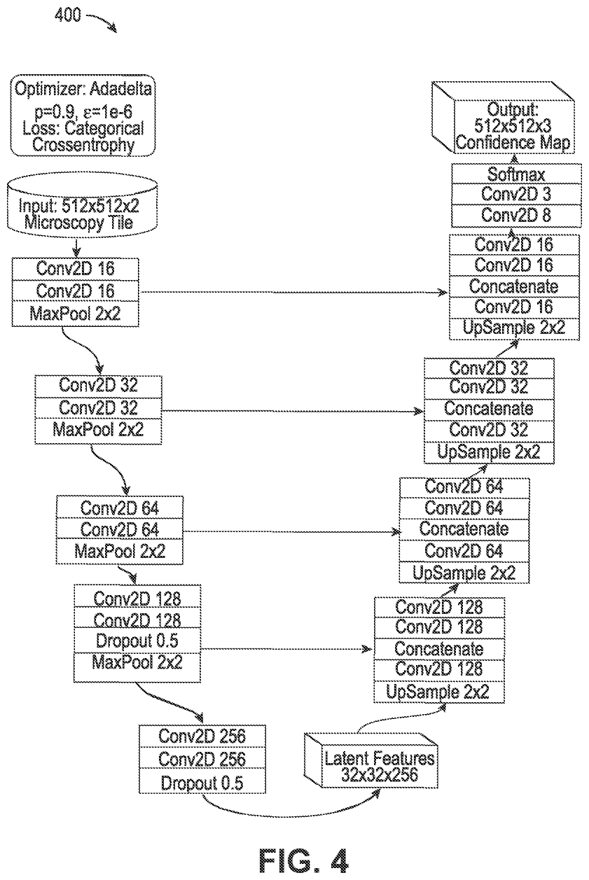

FIG. 4 illustrates an architecture of a convolutional neural network model 400 that was used during the experimentation. The model 400 generally is a deep neural network learning model initially based on the U-Net encoder-decoder architecture, but modified such that it was downscaled to approximately two million parameters. The resulting architecture can be useful for image segmentation problems, especially in histopathology, because its residual connections forward fine-grained details from the encode path to the decode path for fine-grain segmentation. The model 400 was built using PyTorch with convolutional layers to extract information about texture and shape. The model 400 was configured to translate a two-channel fluorescence patch input into a three-class segmentation patch. Thus, the two fluorescence channels were fed as input together, while three confidence value were emitted (one for each class), with the highest chosen to produce the segmentation map.

The input patches, with their corresponding ground truth segmentation patches, were used to train the model 400 through backpropagation. All inputs were normalized to [0.0, 1.0] floating-point. Model 400 performed gradient descent using the AdaDelta algorithm, with=0.9 (decay rate),=1e-6 (numerical stability term), and gradient norm clipping of 1.0 to prevent an exploding gradient. Loss was calculated using categorical crossentropy. Accuracy was measured using Dice score, as reflected in the equation below, where A and B denote images being compared.

$$Dice = \frac{2 * \vert A ⋂ B \vert}{\vert A \vert + \vert B \vert}$$

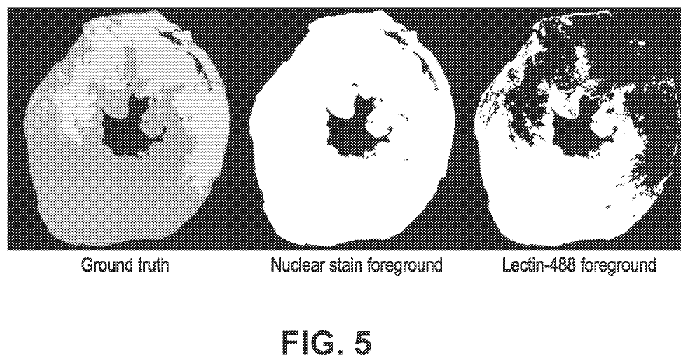

Semantic preprocessing can be a part of the preprocessing method 150. It involves two important steps: extracting a metric from an image and adjusting the image such that the image moves closer to a target value. In the experimentation, a basic variant of this methodology was implemented. As shown for example in FIG. 5, each heart section consisted of two images, each of which needed accompanying binary segmentation information. The nuclear stain image was associated with “none” vs non-“none” regions, whereas the lectin-488 image showed “normal” vs “not-normal” regions. The segmentation can be obtained via approximation or evaluation. FIG. 5 illustrates foreground/background region of interest segmentation for a sample section, for both input channels. As detailed below, the segmentation can than be used to adjust the corresponding microscopy image independently via semantic preprocessing.

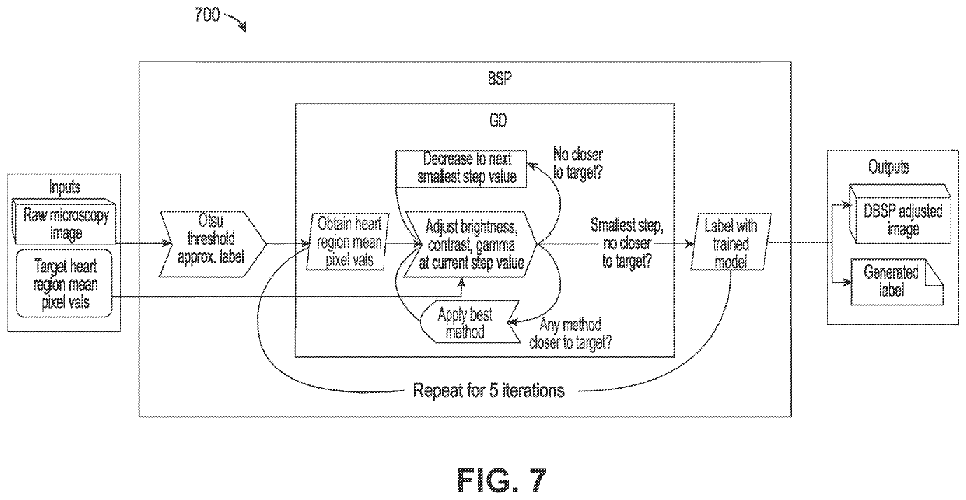

In this case, Otsu thresholding was used as an approximation. The Otsu method performs automatic image thresholding by returning a single intensity threshold that separates pixels into two classes (e.g., foreground and background). Then, mean pixel values for each of the two regions were extracted (the mean background brightness and the mean foreground brightness). These two values were treated like a two-dimensional coordinate. The same was extracted from a known good section and used as a target. Then, the gamma of the image was iteratively adjusted in 5% steps up or down depending on which direction moves closer to the target. The gamma generally defines the relationship between the numerical value of a pixel and its actual luminance. When either adjustment moves further away, the iterative adjustment of the image was stopped. The process for executing this distance-minimization brightness adjustment is illustrated in FIG. 7.

Bootstrapped semantic preprocessing can also be used in the preprocessing method 150 to take advantage of the statistical phenomenon of bootstrapping. When taking an SP-adjusted image and re-sampling it with a trained model and repeating for a number of iterations, one can asymptomatically converge towards a stable adjusted image and label that is almost always much higher-quality than the Otsu approximation or initial model evaluations. Accordingly, during experimentation, semantic preprocessing was applied in 5 iterations. First, each SP-adjusted image was fed to the model 400 to produce a new segmentation map (label) used to run semantic preprocessing. Then, convergence on a high-quality segmentation and a “best” adjusted version of the input images occurred. To produce a quality ground truth data label when starting with no ground truth or only an approximation, one can predict on samples iteratively, converging towards a quality data label. For the experimental dataset, analyses and hypotheses concerning the data were formulated to inform the bootstrapping process.

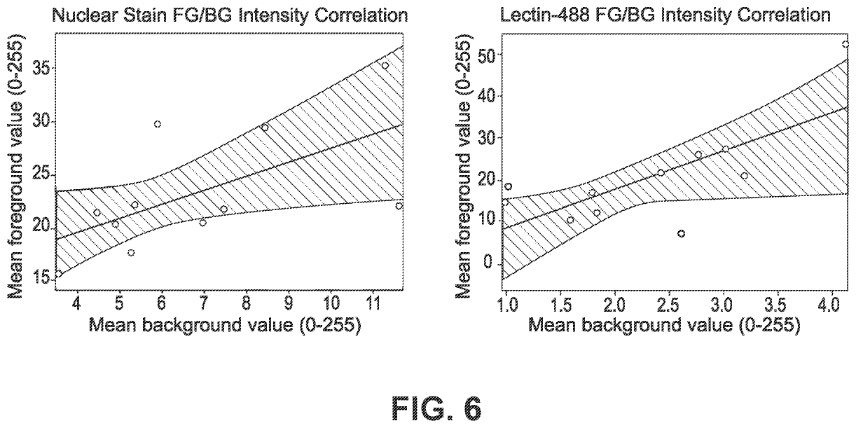

The bootstrapped semantic preprocessing approach can be adaptable to any combination of adjustment algorithms desired. For the experimentation dataset and a simple bootstrapped semantic preprocessing implementation, a gamma adjustment was selected because the foreground and background average intensities for each of the two input channels were positively correlated. FIG. 6 illustrates correlation plots for the Cohort 1 nuclear stain and lectin-488 channel average class area pixel values. In both scenarios, the average pixel value for each class area was positively correlated, and therefore they were being affected similarly by global microscopy session conditions. Hyperbolae are 95% confidence intervals. For nuclear stain, the correlation coefficient was 0.61, the r-squared (r2) was 0.3738, and the p-value was 0.0456. For lectin-488, the correlation coefficient was 0.72, the r-squared was 0.5198, and the p-value was 0.0123. This data suggested that exposure was the most vulnerable property of fluorescent nanoparticle imaging, dependent on variables including nanomarker density, exposure time, whole slide microscopy stitching algorithm consistency, and other variables.

By adjusting the exposure via whole image gamma adjustment, the bootstrapped semantic preprocessing approach can exploit those correlated class intensities to adjust the brightness of the whole image and reach an intensity target. Since foreground and background pixels are correlated, a somewhat inaccurate region of interest segmentation map with contracted or expanded borders but majority coverage may exhibit class average pixel values correlated with those of an accurate segmentation map. Therefore, using a binary (two-class) Otsu thresholding on both foreground and background to generate preliminary approximate segmentation maps, one can adjust the raw input images and then repeat steps of trained model prediction followed by semantic preprocessing using the resulting segmentation maps, thereby generating better segmentation maps each time through the bootstrapping process. At each step, adjustments can be applied to the original raw images in the data collection cohort, as opposed to the adjusted images from the previous step, to ensure that erroneous adjustments do not destroy information needed in future steps. Through this bootstrapped semantic preprocessing approach, the model 400 can effectively normalize unknown data to a state more consistent with the training set distribution.

The gradient descent bootstrapped semantic preprocessing approach, building upon, and adding adjustments to bootstrapped semantic preprocessing, steps down a semantic gradient much more deliberately. The gradient descent bootstrapped semantic preprocessing approach considers both the mean and the standard deviation of each class area's pixel values and probes the gradient towards the targe image metric using a combination of contrast, brightness, and gamma. Thus, each additional class in the image adds two dimensions to the semantic space. During experimentation, where binary segmented images were being adjusted independently, a four-dimensional gradient was being navigated (two mean dimensions and two standard deviation dimensions).

First, as with bootstrapped semantic preprocessing, the gradient descent bootstrapped semantic preprocessing approach includes obtaining an approximate class map starting with applying an Otsu threshold. Then, metrics including the mean and standard deviation of each class area are extracted. Next, the image is adjusted by each metric using a large step: contrast, brightness, and gamma (each by 10% during experimentation). One can then measure which method gets closest to the class area means and standard deviations of the target image. If the distance is closed, the change to the image can then be applied and the process can continue. If the distance is not closed, then the step size can be reduced by an increment (e.g., by 1% to 9%) at a time. Once no change can close the distance with the target image, the process can be stopped. Then, again as with bootstrapped semantic preprocessing, the trained ensemble can be used to evaluate and vote on a new segmentation map with the adjusted image, and this can be repeated for a number of iterations (e.g., 5 iterations).

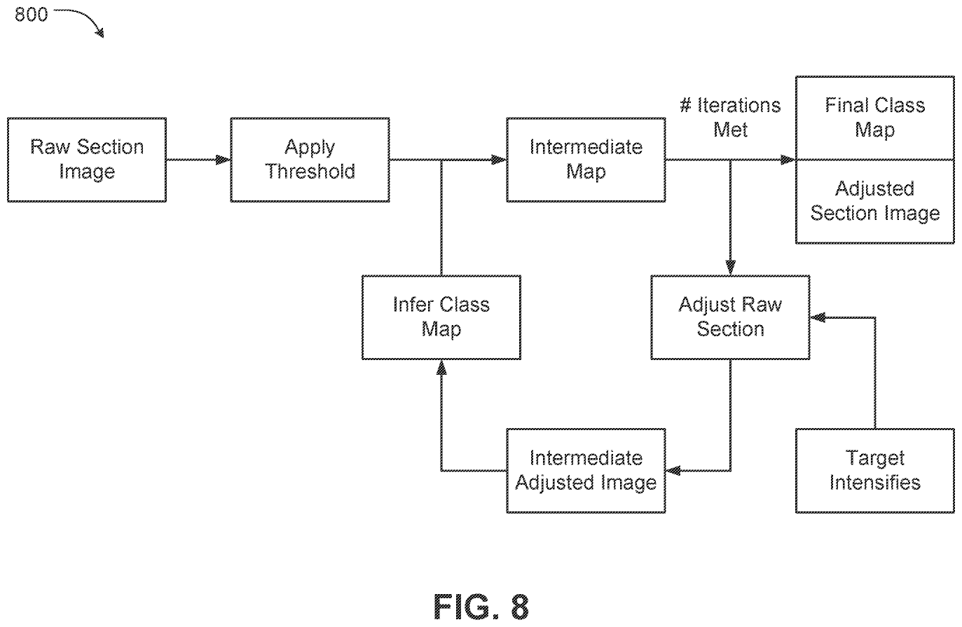

FIG. 7 illustrates a flowchart of an example process 700, including a bootstrapped semantic preprocessing approach and the gradient descent bootstrapped semantic preprocessing approach. The process 700 provides an example illustration showing a possible implementation of the preprocessing method 150. FIG. 8 illustrates a flowchart of another example process 800, showing a bootstrapped semantic preprocessing approach without gradient descent functionality. The process 800 provides another example illustration showing a possible implementation of the preprocessing method 150.

In active learning processes, machine learning algorithms of all types can grow their training set and accuracy by predicting on unlabeled samples, and then calculating some quality score that can be used to determine the most useful samples to submit for expert labeling. However, this process can still leave the human expert with a significant workload. One can use snapshots of the same model over the course of its training that capture differences in predictions dependent on each snapshot's position upon the error gradient surface. Then, an ensemble of the snapshots can be used to vote on model predictions by choosing the plurality result at each pixel of an image, and then calculating confidence from the agreement on that vote.

In this manner, expert workload can be minimized by only submitting predictions with the highest confidence to the expert, and only asking the expert to accept or reject the predictions for inclusion in the data set rather than asking the expert to manually label images. Applied iteratively, this process can produce additional samples for inclusion into the training set after each iteration. However, this process yields diminishing returns on samples each iteration, and many samples end up discarded. The ensemble confidence vote often overfits for samples that most closely resemble the training dataset distribution in terms of texture, feature distribution, brightness levels, and other variables. When microscopy is inconsistent, out-of-distribution samples can produce the lowest quality scored and ensemble votes. Moreover, after each iteration, the ensemble the ensemble often deepens its preference for the feature properties it is already choosing due to their increasing frequency in the training dataset.

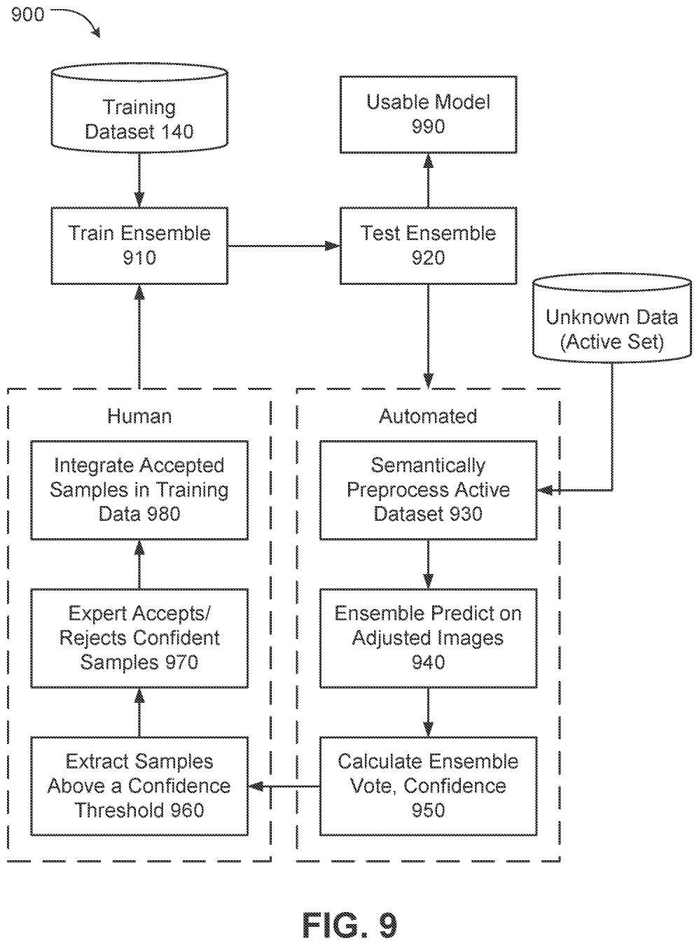

FIG. 9 illustrates a flowchart of an example process 900 for active deep learning that can be performed in conjunction with the preprocessing method 150, and overcomes the aforementioned disadvantages. The process 900 can be used to remedy overfitting issues by deeply integrating bootstrapped semantic preprocessing. As such, the process 900 promotes a reversal of the diminishing returns trend by normalizing out-of-distribution samples to the distribution of the training dataset 140, thereby leading to acceptance of more samples into the training dataset 140.

At step 910, the process 900 includes training a model (e.g., the model 400) on the core training dataset 140 that is already preprocessed. For example, the model can be trained for 110 epochs, and snapshots can be saved during the training at epochs 90, 100, and 110 (or similar intervals), thereby creating an ensemble of 3 models M={M₉₀, M₁₀₀, M₁₁₀}, or other suitable number of models. At step 920, the process 900 optionally includes testing the ensemble against test data for cross-validation. At step 930, the process 900 includes using the final, most-trained snapshot (e.g., M₁₁₀) to preprocess and predict on sections in the active (unknown) dataset Z. At step 940, for each section in the active dataset, the process 900 includes, for the remaining snapshots in the ensemble (e.g., M₉₀ and M₁₀₀), predicting on the given section using the adjusted inputs generated by the most-trained snapshot model (e.g., M₁₁₀).

At step 950, the process 900 includes calculating a per-pixel vote by the ensemble for the given section. The plurality class for each pixel can represent the ensemble's segmentation of the section Z_{ensemble}. Use of an odd number of models can prevent ties in cases of even class counts. The proportion of votes for the winner at each pixel makes up the confidence map Z_{conf}. The confidence f is the computed average of Z_{conf} across the whole section. At step 960, process 900 includes deciding, by the expert, on a confidence threshold fₜₕᵣₑₛₕ. The expert can choose the confidence threshold to yield a number of sections that can be evaluated in a reasonable time. For example, for one hour of work, 12 sections above the confidence threshold could be the target. The expert can choose the confidence thresholds each iteration at the end of training, and thus the confidence thresholds can change over time. At step 970, the process 900 includes leaving sections with f<fₜₕᵣₑₛₕ in the active dataset. Sections with f≥fₜₕᵣₑₛₕ can be evaluated by the expert to accept or reject for inclusion into the training dataset 140. At step 980, the process 900 can loop back and repeat the first step, this time with the training dataset 140 being expanded with the samples accepted into the training dataset 140 by the expert. Adjusted images can be used as the inputs, and plurality voted ensemble segmentations Z_{ensemble} can be used as the ground truths.

During experimentation, 110 epochs was chosen as a carry-over from previous experimentation. 100 epochs was found to be computationally feasible while being comfortable past the point of training loss stability. An extra 10 epochs were added to create a tiebreaker snapshot in a snapshotting of every 10 epochs starting from epoch 10. This was reduced to a last-three snapshots strategy given the associated tailing loss stability region. Process 900 can ultimately be used to generate a usable model 990, where the usable model 990 can be used to process images after training via the expanded training dataset 140.

An expert hand-picked section can be used as the brightness target for different approaches including histogram matching, bootstrapped semantic preprocessing, and gradient descent bootstrapped semantic preprocessing. By running bootstrapped semantic preprocessing and gradient descent bootstrapped semantic preprocessing using the final snapshot (M₁₁₀), the highest quality result was obtained during experimentation using the most-trained snapshot, and then the consensus of the remaining snapshots was calculated. Using one of the two earlier snapshots to preprocess the section has a higher probability of a lower-quality adjustment. The hand-picked confidence threshold ensures that the work done by the expert is both doable in a reasonable time frame (˜1 hour) and that only the highest-quality samples are selected, thereby negating the need for the expert to reevaluate the entire active dataset each iteration. A minimum threshold of 90% can be used to filter methods with low-confidence (and thus unstable) ensembles, ensuring time and work is not wasted.

Since the specific application of active deep learning used in this context is image segmentation, and each pixel is subject to classification, the numbering of the input and output parameters per section can be on the order of 100,000,000 (e.g., such as for whole-slide images). Thus, it is inevitable that some noise will be introduced, such as with dust particle, smears, and other factors. As such, in this case during experimentation, quick adjustments were admitted during expert evaluation that are reasonable within the timespan of analyzing a section for acceptance or rejection; actions such as erasing noise particles or bucket filling areas that are clearly misclassified. For samples that were accepted, the inventors found based on their experiments (using the principles described herein) that combined evaluation and edits should take a mean of 5 minutes per whole section. For samples that were rejected, the inventors found that an analysis and rejection decision should take a mean of 1 minute. As soon as fine detail manual edits would be required on longer timescales similar to the several hours required for manual ground truth generation (e.g., more than 5 minutes, 10 minutes, 30 minutes, 1 hour, 2 hours, etc.), in some embodiments this section can be rejected to maintain the spirit of minimizing the expert's labor while allowing evaluation of images with orders of magnitude higher resolution.

The preprocessing approaches, including bootstrapped semantic preprocessing and gradient descent bootstrapped semantic preprocessing, were evaluated during experimentation against other competing preprocessing techniques to benchmark their performance. The different competing techniques used included Difference of Gaussians (DoG), histogram equalization (HE), adaptive histogram equalization (AHE), and histogram matching (HM). Difference of Gaussians subtracts two versions of an image: one with a higher Gaussian blur, and one with a lower Gaussian blue. In this context, higher and lower refer to the standard deviation of the Gaussian convolution operator. The effect of Difference of Gaussians is a band-pass filter that preserves a band center between the two blur levels while attenuating signals outside of that center.

Histogram equalization works by obtaining the cumulative distribution of the pixels of an image, and redistributing the most common values, mapping values in the source image to a new value that ensures a uniform probability distribution function and also a linear cumulative distribution function. By this flattening and linearizing, histogram equalization acts as a special form of the more general “histogram specification” algorithm targeting the uniform distribution. Histogram equalization notably does not use semantic features, but rather semantic features such as class areas and texture affect it indirectly, and it does not consider the dataset distribution.

Adaptive histogram equalization applies histogram equalization as a sliding window operation by applying its transformation function to the center pixel in each window. In addition, to prevent over amplification of near constant regions, the cumulative distribution function is clipped before applying the transformation to limit contrast. Histogram matching is another case of histogram specification where the target histogram is not a uniform distribution but instead another image's histogram. Thus, the pixel remappings are chosen to match the distribution curves of the target. Histogram matching also is not a semantic method, as it functions without regard for features of class areas. An adjustment that works for a two-class image with a small foreground accordingly may yield odd contrast changes for images with large foregrounds.

Two experiments were performed to evaluate the bootstrapped semantic preprocessing active learning methodology. First, a verification experiment was conducted on only Cohort 1, utilizing expert-made ground truths to confirm that bootstrapped semantic preprocessing and active learning are indeed improving the ensemble. Second, a large real-world unknown data experiment was conducted using Cohort 2 and Cohort 3 as the active dataset to demonstrate the speed and volume of data labeling possible using the preprocessing method 150.

The first experiment using only Cohort 1 was performed to verify that preprocessing and dataset growth via active learning was in fact improving performance. Since Cohort 1 has expert-created ground truths, accuracy could be measured on both test data and the active dataset being evaluated. The eleven section of Cohort 1 were split into two subsets, with six sections used for training and five sections used for the active dataset. Six-fold leave-one-out cross-validation was performed on the training portion using a 4/1/1 train/validation/test split for each fold, where each section acted as the test section for a fold.

Each iteration for each preprocessing technique was done as follows. The six-fold ensembles were trained, and any accepted sections were included in the training dataset for all folds. Then, each ensemble was tested for cross-validation. Next, the least overfit fold (lowest test Dice) ensemble preprocesses active dataset section using the given technique, predicts, and then votes on final composite prediction maps. Then, with ground truths as reference, Dice accuracy was recorded with per-section confidence and mean confidence. Next, a human expert evaluated the active dataset section that read at least 97% confidence, deciding to accept or reject into the training dataset. Then, accepted samples were integrated into the training dataset for the next iteration.

The “least overfit” fold each iteration was used to pick the ensemble with the lowest likelihood of settling in an untenable local minima, using model parameters with the greatest probability for improvement. An overfit model has a high probability of producing votes with high confidence on poor quality labels. So, the bootstrapped semantic preprocessing and gradient descent bootstrapped semantic preprocessing approaches can avoid such a scenario by picking samples that produce high agreement even from a lower-fit model.

While metrics during training and validation were tracked using only the 512×512 input and output patches, for testing, all the predicted patches of the test section were stitched together to reconstruct the whole section. However, the model created some amount of noise at the patch edges due to the lack of context past those edges, leaving a visible grid pattern in the stitching. To combat this, only the 256×256 center of the output patch was used, discarding a 128-pixel buffer zone on all sides as trim, and the 512×512 window was slid a smaller distance of 256 pixels at a time. The method of “patch-wise” interpolation resulted in a slightly longer prediction time in exchange for a very consistent full-section region of interest segmentation map. Final performance metrics were defined by comparing these full-section predictions of the test section to the ground truth of the test section.

The number of sample patches that are both 97% confident and accepted by the expert were recorded in each iteration. The 97% threshold was chosen in earlier experiments as the median confidence of bootstrapped semantic preprocessing. It often outperformed other methods so thoroughly that the majority of the of the active set would be included each iteration using lower thresholds. Thus, for the Cohort 1 experiment, the threshold needed to be strict to identify a difference. It is notable that the expert evaluated and accepted whole sections, and that the figures reflect the sample counts of the combined sections.

To test how robust the bootstrapped semantic preprocessing and gradient descent bootstrapped semantic preprocessing approaches are in a real-world active learning scenario, three iterations were performed (when yields allowed) of active learning for the four preprocessing methods of raw, unaltered images (the control), histogram equalization, histogram matching targeting the test section, bootstrapped semantic preprocessing, and gradient descent bootstrapped semantic preprocessing. Three iterations were chosen to save on compute cost and time, as the multi-fold structure of the experiment was extremely compute-intensive. To confirm effectiveness after these comparisons, the best method as measured at that third iteration (gradient descent bootstrapped semantic preprocessing) was further iterated until it yielded no further samples, as an example of its performance through an entire dataset.

Each preprocessing method was evaluated in four folds, with the data generated once randomly and used for all methods in all iterations. The Cohort 1 sections acted as the base dataset, with every Cohort 1 section in one fold's test set, using the following train/validation/test splits: folds A, B, and C at 6/2/3, fold D at 7/2/2. The unlabeled data used for the active set Z consisted of Cohorts 2 and 3. When samples were accepted, all accepted samples were added to the training dataset for all four folds in subsequent iterations.

Each iteration for each preprocessing method was done as follows. First, the four-fold ensembles were trained, and each training set was expanded with any accepted sections. Second, each ensemble was tested for cross-validation. Third, the least overfit (lowest test Dice) fold ensemble was used to preprocess the active dataset sections using the given method, predict, and then vote on the final composite prediction map. Fourth, per-section confidence and mean confidence on the active dataset was recorded. Fifth, a human expert chose a confidence threshold that produced roughly one hour of work or approximately 12 sections. Sections that were above the threshold were evaluated for accept or reject. Sixth, accepted samples were integrated into the training dataset for the next iteration. Statistical significance from iteration to iteration was calculated using a T-test for related samples, counting each whole section as a sample and its Dice score as the sample statistic.

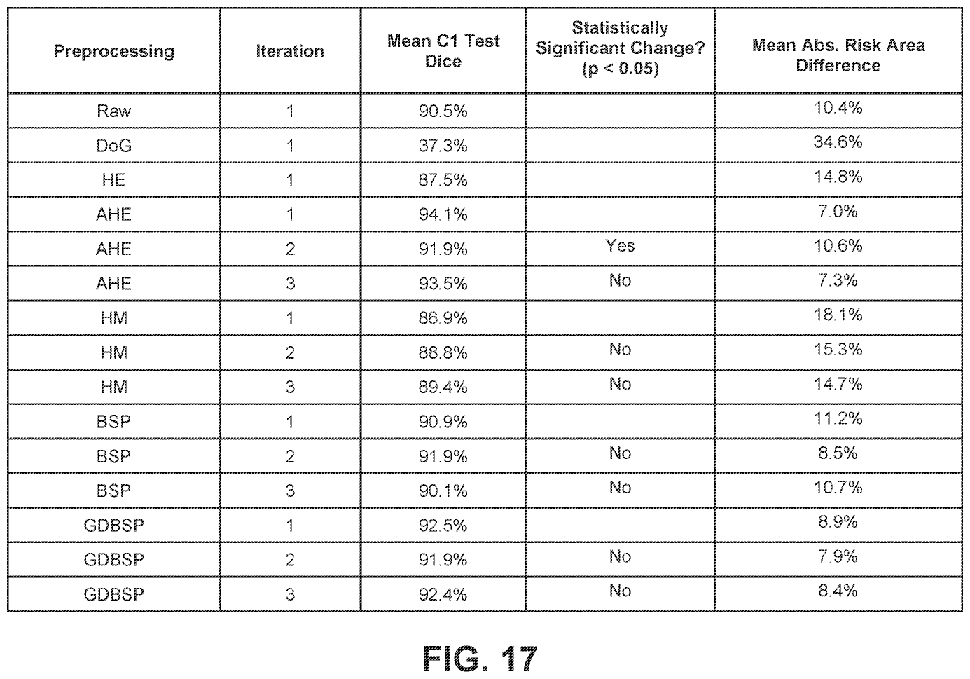

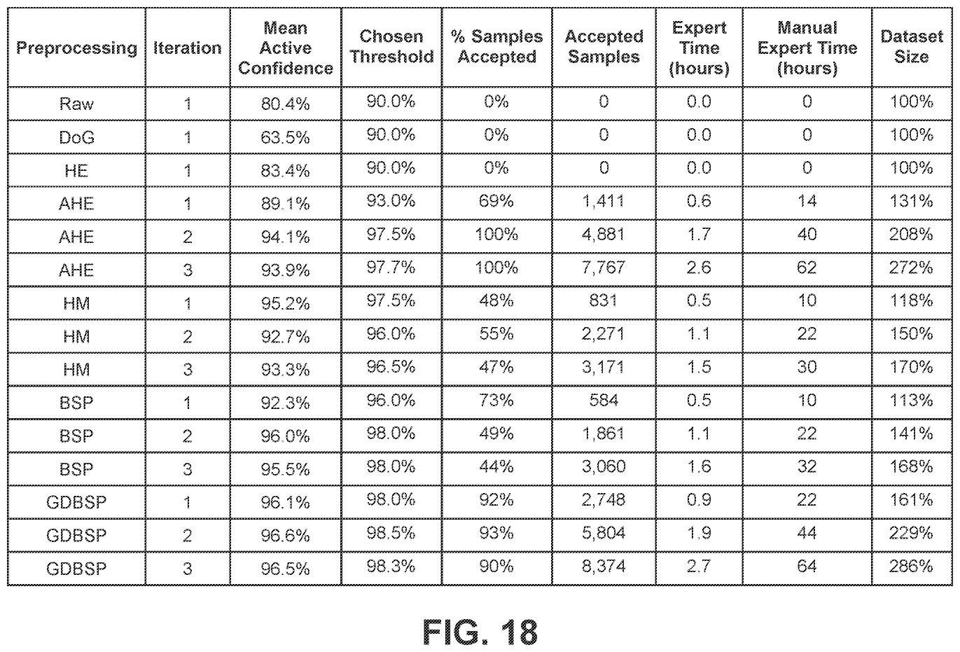

The Cohort 1 experiment demonstrated remarkable results by the bootstrapped semantic preprocessing, as reflected by the data shown in the table of FIG. 18. While the ensemble run using raw inputs and adaptive histogram equalization performed well during testing on the active dataset, the snapshot ensemble did not have enough confidence to reach the threshold, suggesting unstable training and thus the disagreement between the last three snapshots. Meanwhile, the bootstrapped semantic preprocessing approach produced good accuracy and excellent confidence, suggesting stability in the last three snapshots. Also, the gradient descent bootstrapped semantic preprocessing approach is extremely poor. Upon analyzing the data, it appeared as though the gradient descent bootstrapped semantic preprocessing approach suffered from data starvation when too few samples were using in the training dataset. Ultimately, the bootstrapped semantic preprocessing approach was able to grow the dataset by 66% and increase accuracy by 1.9% on the test folds and 3% on the remaining active dataset. One can conclude that the bootstrapped semantic preprocessing approach and active learning improve the effectiveness of an ensemble and its generalizability to unknown data. The table shown in FIG. 17 illustrates data from the Cohorts 2 and 3 experiments relative to the Cohort 1 test results.

From the table shown in FIG. 18, it can be seen that the ensemble shows the best confidence with the gradient descent bootstrapped semantic preprocessing approach, improving to 96.5% in the third iteration. The active set sample integration of adaptive histogram equalization and bootstrapped semantic preprocessing are excellent, but that of gradient descent bootstrapped semantic preprocessing is outstanding. It is notable to recall that the base dataset (training, validation, testing) consisted of Cohort 1, with 4,513 samples. With the raw input images, the Difference of Gaussians, and the histogram equalization approaches, no samples reached the minimum 90% confidence threshold. The Histogram matching and the bootstrapped semantic preprocessing approaches were able to grow the dataset to 170% and 168% of its original size, respectively. The adaptive histogram equalization approach greatly improved on this, growing the dataset to 272%. The gradient descent bootstrapped semantic preprocessing approach improves on this even further, reaching 286%.

Qualitatively, the expert opinion during the sample review process was that the segmentations for the adaptive histogram equalization approach and the gradient descent bootstrapped semantic preprocessing approach improved markedly over time. In addition, samples that previously were evaluated poorly improved in later iteration to be accepted, especially those from Cohort 3. It is notable that the advanced methods including the adaptive histogram equalization approach, the bootstrapped semantic preprocessing approach, and the gradient descent bootstrapped semantic preprocessing approach appeared to have unchanged or sometime decreasing Dice accuracy during testing on Cohort 1 over their iterations. Next to the expert opinion that segmentation quality on the active dataset was improving, this was a puzzling occurrence.

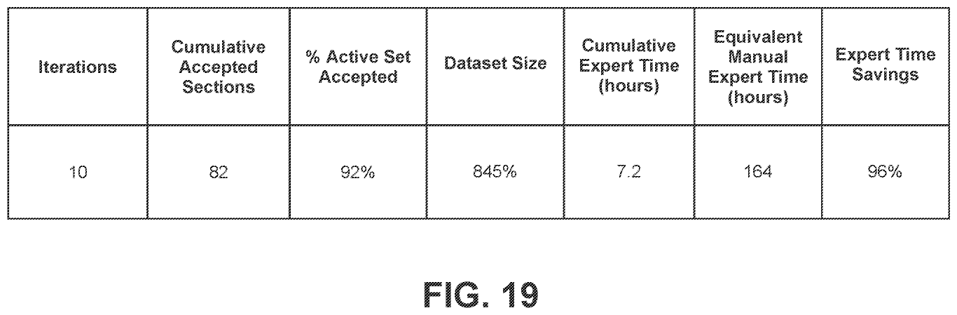

An analysis of expert time showed clear wins for automatic labeling. Manual labeling of regions of interest on the high-resolution images would take on the order of days of work. However, with automatic labeling this was reduced to a mere handful of hours. FIG. 19 shows a full evaluation of the gradient descent bootstrapped semantic preprocessing approach, where a 96% reduction in expert working time was seen while the dataset was multiplied in size by more than a factor of eight.

The experimentation showed robustness of the bootstrapped semantic preprocessing approach with small initial datasets. While with the gradient descent bootstrapped semantic preprocessing approach the results seemed brittle with the small initial datasets, as soon as there was sufficient data the gradient descent bootstrapped semantic preprocessing approach appeared to outperform all other methods tested in terms of automatic labeling. Accordingly, the results suggested that the bootstrapped semantic preprocessing approach might serve well as a first step in a data starvation scenario, followed up by either the gradient descent bootstrapped semantic preprocessing approach or the adaptive histogram equalization approach in subsequent iterations. The raw-input control, Difference of Gaussians, and histogram equalization approaches accepted no samples (even with a 90% minimum confidence threshold), suggesting the nature of the dataset has a large effect on acceptance results.

The sample acceptance rates of the various preprocessing methods can be compared with a more standard active deep learning approach that does not utilize preprocessing methods, and might average about an 11% acceptance rate for an active dataset per iteration. When using the adaptive histogram equalization approach, an average of about a 13.9% acceptance rate can be achieved for an active dataset per iteration. When using the gradient descent bootstrapped semantic preprocessing approach, an average of about an 18.1% acceptance rate can be achieved for an active dataset per iteration, even with strict confidence thresholds of 98% or higher. Thus, the gradient descent bootstrapped semantic preprocessing approach greatly enhances the automatic labeling capabilities in an active deep learning.

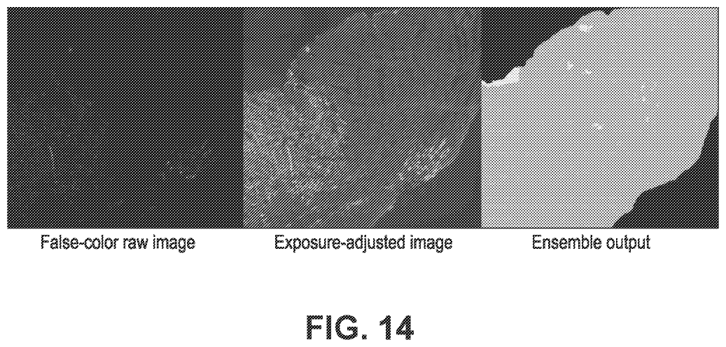

The accepted sections for the bootstrapped semantic preprocessing approach and the gradient descent bootstrapped semantic preprocessing approach tended to weight heavily towards Cohort 2 in early iteration, with Cohort 2 only appearing in later iterations (if at all). Analysis of Cohort 3 lectin-488 images revealed a possible cause in that the images were generated with the perfusion of an additional dystrophin nanoparticle which has a slight response in the lectin-488 imaging wavelength. This brightened the background and non-signal areas of lectin-488 images. FIG. 14 provides a demonstration of an overfitting ensemble misclassifying labels on a Cohort 3 section, lectin-488 channel. The left shows the “adjusted” image, which was unchanged by semantic preprocessing from the raw image. The middle shows the same as the left, but exposure boosted for better visibility. The right shows the ensemble voted segmentation map. One can see from the illustration in FIG. 14 that significant differences in non-signal region background noise that are not present in Cohort 2, or in the original training dataset, are present. The model misclassifies these regions as “normal” regions.

The gradient descent bootstrapped semantic preprocessing approach showed strong gains on the same Cohort 3 images deeper in its iterations. By iteration 5, samples that previously produced poor segmentations suddenly were being evaluated as very high quality. This result may be due to active deep learning “finding the universal mean” as the accepted data takes over the bulk proportion of the training set. At the least, active deep learning finds the mean of the collected data. This occurs even as its test Dice on Cohort 1 drops slightly, though not enough to be statistically signina. This is also true of the bootstrapped semantic preprocessing approach and the adaptive histogram equalization approach. It could be that, as an extension to theories about bias and variations from microscopic image acquisition, the small initial cohort simply does not best represent the wider universe of possible data. As the model is fit to more data to discover the new mean, one might expect that the fit drops on the initial dataset. Thus, the accuracy of the model on Cohort 1 testing is not necessarily reflective of its accuracy on the wider universe of data.

Analysis of the Cohort 1 test segmentations produced by the gradient descent bootstrapped semantic preprocessing approach in its later iterations supports this notion. Several outlier samples produced particularly poor Dice scores. On reflection, the outliers fell into two categories: samples that would on second analysis be rejected for manual ground truth and inclusion into the training dataset due to poor sectioning or imaging quality, and samples for which the manual ground truth was of low initial quality. In the second category, the expert determined that the segmentation produced by the gradient descent bootstrapped semantic preprocessing approach, which was nominally scored with a lower Dice value, would make a more accurate ground truth. Of the 11 sections of Cohort 1, two were targeted as potential candidates to be discarded, and another three were targeted as potential candidates for relabeling. The model was robust in this scenario and, in a qualitative expert's opinion, was able to improve its performance on unknown data via the active learning process, especially on Cohort 3 samples.

The experimentation demonstrated that active deep learning for automatic labeling, a promising method for expanding the ground truth of data sets, was sensitive to inconsistent microscopy conditions and tended to overfit the training data distribution. In order to more effectively evaluate and automatically create ground truths for uncertain samples, the uncertain samples can be normalized to the training dataset distribution using preprocessing adjustments that adequately cover the space of possible variance of a particular image type. The semantic preprocessing methods discussed above contained in predictions to robustly apply these adjustments, short-circuit overfitting problems, and generate high-quality normalizations and region of interest labels from unlabeled data. Using the semantic preprocessing methods, 92% of the automatic labels generated for the unlabeled data cohort were accepted, thereby expanding the labeled training dataset by 845%. Also, the semantic preprocessing methods were demonstrated to provide time savings of 96% on data labeling efforts for medical researchers. The performance was demonstrated through patch-wise interpolation of whole slide images, allowing for full preservation of image detail and region label fidelity with no loss of information resulting from downscaling.

It was observed that increasing segmentation quality on unknown data, especially out-of-distribution samples from an unlabeled cohort, correlated with stagnant or decreasing Dice scores on the initial cohort. This observation suggested that the accuracy on the initial cohort is not reflective of accuracy on the wider universe of data. Active learning and automatic labeling may allow discovery of the universal data mean, or at least the mean of a total data pool. Evidence was gathered by observing five outlier labels from Cohort 1 testing that an expert identified as suboptimal, with the sections or ground truth labels potentially in need of re-evaluation.

Similar approaches are possible and could be explored that use semantic preprocessing approaches integrated as a bootstrapping solution. For example, other types of datasets beyond histopathological images could also be handled in a similar manner, such as diagnostic magnetic resonance images (MRI). In such a case, metrics such as Fourier k-space data could assist adjustment. The use of semantic preprocessing approaches as discussed herein should enable design of more complex and powerful algorithms to advance active learning and automatic labeling for a myriad of applications.

The ability to formulate a method for measuring accuracy beyond the initial cohort would help measure generalization on unknown data. Measuring the adaptability of active learning over its iterations may also prove fruitful, possibly by providing a model with data known to be outliers as the initial dataset. The quality metric for confidence measurement could also be reformulated. Extracting the per-pixel confidence vote values and using them to construct a confidence map of each sample could provide a quality metric similar that helps the expert determine where to focus attentions.

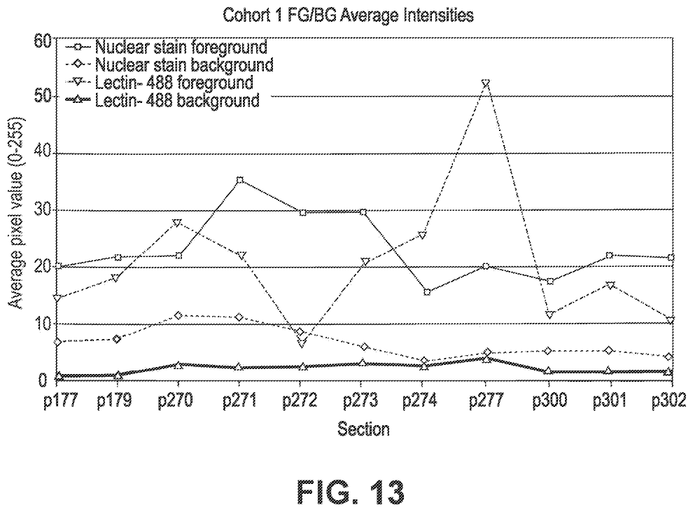

To demonstrate the whole slide data collection inconsistency problems that the semantic preprocessing approaches help solve, a derived semantic metric was used for studying during further experimentation. The two input channels were each separated into a binary “signal” foreground and “non-signal” background according to the ground truth segmentation map, becoming binary images. The Cohort 1 sections manifested interesting and sometimes extreme variations in brightness from the Cohort 1 average. The most obvious example was Process 277, or p277. FIG. 13 illustrates average brightness for foreground and background regions of the nuclear stain and lectin-488 channels of the dataset. The two of these channels were adjusted independently during experimentation. In FIG. 13, p177 is the target, and the large green-channel deviation of p277 is notable. It can be seen that the levtin-488 channel exhibited an exceedingly high foreground average pixel value, with a likewise elevated background average pixel value. As well, p2′72's lecting-488 channel averages lied within a more consistent range.

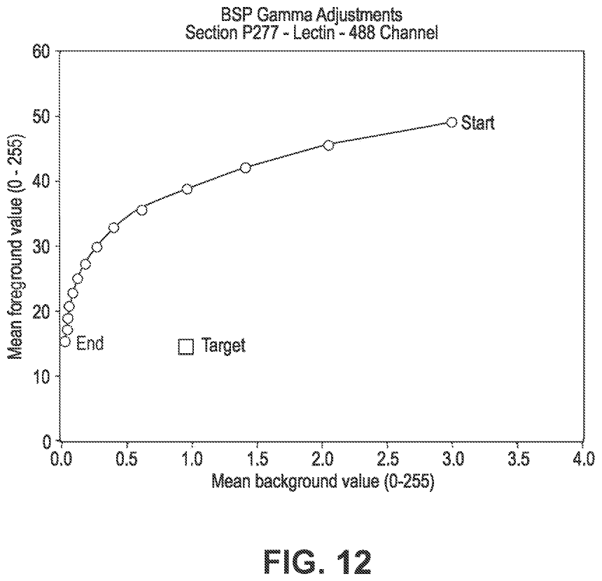

Several of the algorithms tested during experimentation required an adjustment target. The expert-selected target for all such tested algorithms was the image properties of section p177. Its average intensity levels represented a high-quality signal separation between foreground and background, as well as a close match to the dataset average. Further, p177 consistently received high-accuracy evaluations from models where it was left out as the “test” section, suggesting it was a suitable representation of the dataset average. Similar variances to those in the training dataset were present in the active dataset, as shown in FIG. 3. Cohort 2′s nuclear stain channel was exceptionally bright, with most of its interquartile range corresponding to Cohort 1's upper quartile. Cohort 3's lectin-488 channel skewed bright, with its upper quartile matching Cohort 1's maximum. This suggested, and a manual analysis confirmed, that the Cohort 3 lectin-488 backgrounds were much brighter, exhibiting a kind of overexposure. These difference are exactly the type of inconsistency in microscopy that the semantic preprocessing approaches are designed to handle. FIG. 12 illustrates gamma adjustment semantic preprocessing iterations for section p277, levting-488 channel, where the target is the semantic metric of p177.

As noted above, in the bootstrapped semantic preprocessing approach, one can apply semantic processing and predict iteratively, asymptomatically approaching towards an accurate segmentation. A reasonable number of iterations can be chosen to balance a tradeoff between accuracy and evaluation speed. During experimentation, 5 iterations were used, with the Otsu preliminary map acting as a 0^{th} iteration. FIG. 8 illustrates the different Dice accuracies of iterative preprocessing using distance-minimization bootstrapped semantic preprocessing. It can be seen from FIG. 8 that most convergence finishes by the second iteration, with minor improvements beyond that point. Also, while the accuracies of the initial Otsu threshold maps are low, the follow-up semantic preprocessing prediction iterations improve accuracy each time.

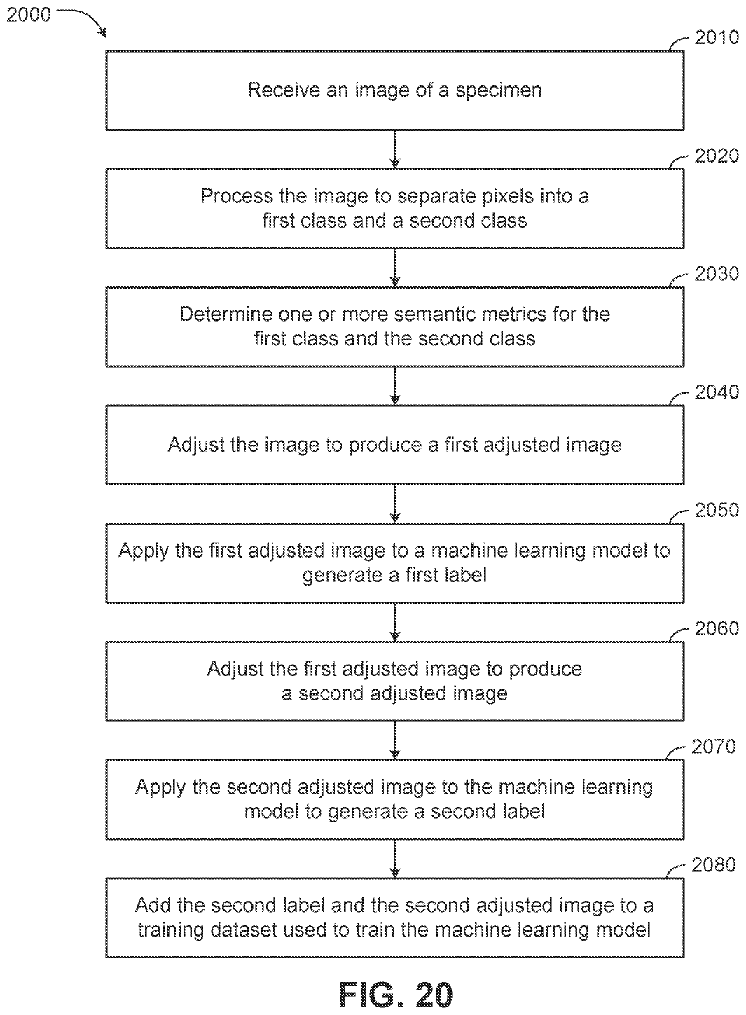

FIG. 20 is a flowchart illustrating an example process 2000 for implementing bootstrapped semantic preprocessing for medical datasets. The process 2000 can be performed by the processing system 100 by executing instructions for performing the preprocessing method 150, for example. The process 2000 can be used to more efficiently and effectively train artificial intelligence used for medical purposes as evidenced by the experimental results detailed and presented above. The process 2000 can include performing preprocessing techniques such as by implementing the techniques including the semantic preprocessing, bootstrapped semantic preprocessing, and/or gradient descent bootstrapped semantic preprocessing approaches as detailed above. The process 2000 can be used to address specific technical challenges that arise in the field of medical artificial intelligence, such as overfitting and other problems as detailed above.

The process 2000 is shown to include receiving an image of a specimen (2010). For example, processing system 100 can receive an image of the specimen 300 from the imaging system 200. The image can be a whole slide histopathology image that is high-resolution and has not experienced any downsizing due to manipulation approaches such as patch-wise interpolation. The processing system 100 can receive the image from the imaging system 200 via any suitable communications methods, including both wired and wireless communications methods. Other types of high-resolution images in addition to whole slide histopathology images can be used.

The process 2000 is also shown to include processing the image to separate pixels into a first class and a second class (2020). For example, the processor 110 can apply an Otsu threshold to the image to separate the pixels in the image into a first class (e.g., foreground) and a second class (e.g., background). In different contexts, the separation of pixels into different classes can mean different things. For example, in the nuclear stain image example discussed above, the first class can be a “none” region and the second class can be a non-“none” region. In the lectin-488 image example, the first class can be a “normal” region and the second class can be a “not-normal” region. Applying an Otsu threshold is just one approach that can be used to preliminarily separate the pixels in the image into different classes. The pixels can be divided into more than two classes in some applications.

The process 2000 is also shown to include determining one or more semantic metrics for the image (2030). The processor 110 can determine semantic metrics for pixels in the first class and/or for pixels in the second class or any other additional classes. For example, like in the experiment detailed above, the processor 110 can convert the input image into 8-bit pixel depth, yielding grayscale intensity values from 0 to 255, with 0 being black and 255 being white. The processor 110 can then determine a brightness value for each pixel in the first class and calculate an average of all these values to determine a first average brightness value for the first class of pixels. The processor 110 can likewise determine a value for each pixel in the second class and calculate an average of all the values to determine a second average brightness value for the second class of pixels. The processor 110 can also determine other semantic metrics for different pixel groupings, including contrast values, gamma values, and other metrics. The processor 110 can also determine the standard deviation of different semantic metrics within different groupings of pixels, such as the standard deviation of brightness values in the first class of pixels, the standard deviation of contrast values in the first class of pixels, and the standard deviation of gamma values in the first class of pixels.

The process 2000 is also shown to include adjusting the image to produce a first adjusted image (2040). The processor 110 can adjust the image by comparing the image to a target image, for example. The target image can be a known properly labeled image, for example containing one or more labeled regions of interest. The processor 110 can adjust different metrics associated with the image by a step increment. The step increment can be predetermined or can be determined dynamically, and can be any suitable value such as a 10% step increment. The processor 110 can determine a direction to adjust each metric as well (up or down) depending on which direction moves the metric closer towards the associated metric in the target image (e.g., a third average brightness value associated with a region of the target image). The processor 110 can make multiple iterative adjustments to the image during the process of producing the first adjusted image. If, at a certain point during the iterative process, none of the adjustments being considered by the processor 110 move the image closer towards the target, the processor 110 can change the step increment (e.g., reduce by 1% to 9%) and reassess. Once processor 110 determines that no change can move the image closer towards the target, the processor 110 can end the iterative process and finalize the first adjusted image. The processor 110 can adjust groups of pixels as a whole, or adjust individual pixels within different groups of pixels one by one or piece by piece.

The process 2000 is also shown to include applying the first adjusted image to a machine learning model to generate a first label (2050). For example, the processor 110 can take the finalized first adjusted image and apply the finalized first adjusted image to the model 400 discussed above, or another type of machine learning model. The machine learning model at this point has already been trained at some level, for example using the existing training data in the training dataset 140. Based on its training, the machine learning model can apply and generate a first label for the first adjusted image. The first label can indicate one or more regions of interest within the first adjusted image, among other possible identifying features provided by the first label.

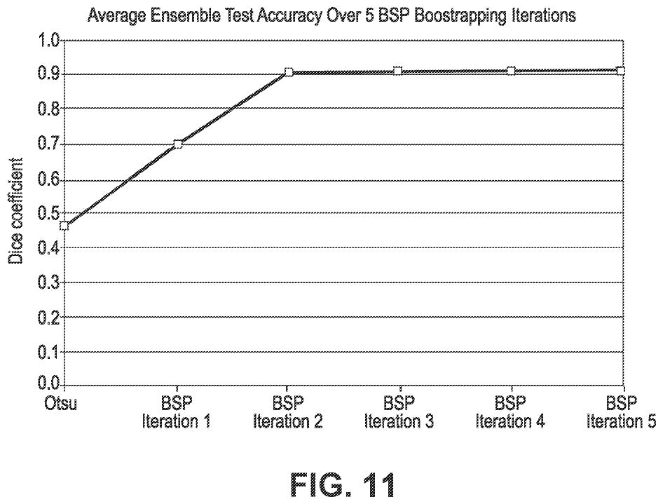

The process 2000 is also shown to include adjusting the first adjusted image to produce a second adjusted image (2060). For example, the processor 110 can essentially repeat steps 2030 and 2040 for the first adjusted image with the first label, in order to determine semantic metrics for the first adjusted image and adjust the first adjusted image towards the target image. For example, the processor 110 can determine a fourth average pixel brightness for the region of interest identified by the first label, and compare that fourth average pixel brightness to the third average pixel brightness value associated with the target image. The processor 110 can iteratively adjust the fourth average pixel brightness by the step increment to close the distance between the fourth average pixel brightness value and the third average pixel brightness value. Process 2000 is also shown to include applying the second adjusted image to the machine learning model to generate a second label (2070). For example, the processor 110 can apply the second adjusted image to the model 400, similar to step 2050. As detailed, any number of iterations in this manner can be used, depending on the application. As shown in FIG. 11, with the testing of bootstrapped semantic preprocessing, most convergence was found to finish by iteration two. However, further iterations continued to improve accuracy (although minimally) and may be desired in different applications.

The process 2000 is also shown to include adding the second label and the second adjusted image to a training dataset used to train the machine learning model (2080). For example, the processor 110 can add the second adjusted image that is normalized to the distribution of the training dataset 140 and the second label indicating one or more regions of interest within the second adjusted image to the training dataset 140. In this manner, the process 2000 can be used to expand training datasets used for medical purposes in order to provide better efficiency (e.g., reduced manual expert labor) and effectiveness of artificial intelligence. As a result, medical professionals can learn more about the manifestations of diseases and develop better technology for both treating and preventing disease.

Although the invention has been described and illustrated in the foregoing illustrative aspects, it is understood that the present disclosure has been made only by way of example, and that numerous changes in the details of implementation of the invention can be made without departing from the spirit and scope of the invention, which is limited only by the claims that follow. Features of the disclosed aspects can be combined and rearranged in various ways.

1. A non-transitory computer-readable storage medium having instructions stored thereon that, when executed by at least one processor, cause the at least one processor to implement operations comprising:
receiving a whole slide histopathology image of a specimen;
processing the image to separate pixels in the image into a first class and a second class;
determining a first average brightness value for the first class of pixels and a second average brightness value for the second class of pixels;
adjusting the first average brightness value for the first class of pixels in the image by a step increment to produce a first adjusted image;
applying the first adjusted image to a machine learning model to generate a first label for the first adjusted image;
adjusting the first adjusted image to produce a second adjusted image;
applying the second adjusted image to the machine learning model to generate a second label for the second adjusted image;
adding the second label and the second adjusted image to a training dataset used to train the machine learning model; and
training the machine learning model using the training dataset.

2. The computer-readable medium of claim 1, wherein adjusting the first average brightness value for the first class of pixels in the image by the step increment to produce the first adjusted image comprises adjusting the first average brightness value such that the first average brightness value moves closer towards a third average brightness value associated with a target image.

3. The computer-readable medium of claim 2, the operations further comprising determining a fourth average brightness value for the first adjusted image, wherein adjusting the first adjusted image to produce the second adjusted image comprises adjusting the fourth average brightness value such that the fourth average brightness value moves closer towards the third average brightness value associated with the target image.

4. The computer-readable medium of claim 2, the operations further comprising adjusting a first average contrast value for the first class of pixels in the image by the step increment to produce the first adjusted image.

5. The computer-readable medium of claim 4, the operations further comprising adjusting a first average gamma value for the first class of pixels in the image by the step increment to produce the first adjusted image.

6. The computer-readable medium of claim 5, further comprising determining a first standard deviation of brightness values for the first class of pixels in the image, a second standard deviation of contrast values for the first class of pixels in the image, and a third standard deviation of gamma values for the first class of pixels in the image, wherein adjusting the first average brightness value, the first average contrast value, and the first average gamma value comprises adjusting the first average brightness value, the first average contrast value, and the first average gamma value such that the first standard deviation moves closer towards a fourth standard deviation of brightness values associated with the target image, the second standard deviation moves closer towards a fifth standard deviation of contrast values associated with the target image, and the third standard deviation moves closer towards a sixth standard deviation of gamma values associated with the target image.

7. The computer-readable medium of claim 1, wherein processing the image to separate the pixels in the image into the first class and the second class comprises processing the image using an Otsu threshold to separate the pixels in the image into the first class and the second class.

8. The computer-readable medium of claim 1, the operations further comprising:
causing the second label and the second adjusted image to be presented to a user via a user interface;
receiving an input from the user via the user interface; and
adding the second label and the second adjusted image to the training dataset based on the input.

9. The computer-readable medium of claim 1, the operations further comprising determining a confidence value for the second label by evaluating the second label using a snapshot ensemble.

10. The computer-readable medium of claim 1, wherein training the machine learning model using the training dataset comprises training a U-Net convolutional neural network.

11. A computer-implemented method, comprising:
receiving an image of a specimen;
processing the image to separate pixels in the image into a first class and a second class;
determining a first average brightness value for the first class of pixels and a second average brightness value for the second class of pixels;
adjusting the first average brightness value for the first class of pixels in the image by a step increment to produce a first adjusted image;
applying the first adjusted image to a machine learning model to generate a first label for the first adjusted image;
adjusting the first adjusted image to produce a second adjusted image;
applying the second adjusted image to the machine learning model to generate a second label for the second adjusted image;
causing the second label and the second adjusted image to be presented to a user via a user interface;
receiving an input from the user via the user interface; and
adding the second label and the second adjusted image to a training dataset used to train the machine learning model based on the input.

12. The method of claim 11, wherein adjusting the first average brightness value for the first class of pixels in the image by the step increment to produce the first adjusted image comprises adjusting the first average brightness value such that the first average brightness value moves closer towards a third average brightness value associated with a target image.

13. The method of claim 12, further comprising adjusting a first average contrast value and a first average gamma value for the first class of pixels in the image by the step increment to produce the first adjusted image.

14. The method of claim 11, wherein processing the image to separate the pixels in the image into the first class and the second class comprises processing the image using an Otsu threshold to separate the pixels in the image into the first class and the second class.

15. The method of claim 11, further comprising determining a confidence value for the second label by evaluating the second label using a snapshot ensemble.

16. The method of claim 12, further comprising determining a first standard deviation of brightness values for the first class of pixels in the image, wherein adjusting the first average brightness value comprises adjusting the first average brightness value such that the first standard deviation moves closer towards a second standard deviation of brightness values associated with the target image.

17. A system comprising:
one or more processors; and
one or more non-transitory computer readable storage media having instructions stored thereon that, when executed by the one or more processors, cause the one or more processors to implement operations comprising:
receiving an image of a specimen;
processing the image to separate pixels in the image into a first class and a second class;
determining a first average brightness value for the first class of pixels and a second average brightness value for the second class of pixels;
adjusting the first average brightness value for the first class of pixels in the image by a step increment to produce a first adjusted image;
applying the first adjusted image to a machine learning model to generate a first label for the first adjusted image;
adjusting the first adjusted image to produce a second adjusted image;
applying the second adjusted image to the machine learning model to generate a second label for the second adjusted image;
adding the second label and the second adjusted image to a training dataset used to train the machine learning model; and
training the machine learning model using the training dataset.

18. The system of claim 17, wherein adjusting the first average brightness value for the first class of pixels in the image by the step increment to produce the first adjusted image comprises adjusting the first average brightness value such that the first average brightness value moves closer towards a third average brightness value associated with a target image.

19. The system of claim 18, the operations further comprising determining a fourth average brightness value for the first adjusted image, wherein adjusting the first adjusted image to produce the second adjusted image comprises adjusting the fourth average brightness value such that the fourth average brightness value moves closer towards the third average brightness value associated with the target image.

20. The system of claim 19, the operations further comprising determining a first standard deviation of brightness values for the first class of pixels in the image, wherein adjusting the first average brightness value comprises adjusting the first average brightness value such that the first standard deviation moves closer towards a second standard deviation of brightness values associated with the target image.
